(19) United States
(12) Patent Application Publication
(10) Pub. No.: US 2007/0133521 A1
(43) Pub. Date: Jun. 14, 2007

(54) System and method for managing telecommunications

(76) Inventor: John Paul McMaster, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/303,066

(22) Filed: Dec. 14, 2005

(51) Int. Cl. H04L 12/66

(52) U.S. Cl. 370/352

(57) ABSTRACT

A system and method for managing telephone communications. An originating telephone carrier originates telephone calls by users and conveys the telephone calls to an internet protocol network provider for termination. The internet protocol network provider conveys the received telephone calls to a service platform comprising a softswitch for termination. The service platform applies one or more services to received telephone calls and routes the terminated telephone calls to a final carrier. A final carrier receives the telephone calls from the service platform and terminates telephone calls. The originating carrier compensates the IP network provider for terminating calls conveyed by the originating carrier, the service platform compensates the IP network provider for telephone calls conveyed by the IP network provider to the service platform for termination, and the final carrier is configured to compensate the service platform for termination of calls received from the service platform or service platform's internet protocol network provider.

### BACKGROUND OF THE INVENTION

1. Field of the Invention

This invention relates to data communications and, more particularly, to telephone communication systems.

2. Description of the Related Art

In the past, households and businesses had generally had no choice in selecting their local telephone company. Generally speaking, consumers were limited to plain old telephone service (POTS) from a local exchange carrier (LEC). An LEC is a telephone company that operates within a local area. Subsequent to the breakup of AT&T, seven independent companies were created with the resulting LECs referred to as incumbent LECs (ILECs). However, during the 1980s, various service providers arose which sought to compete with ILECs in a given market. These competitive access providers (CAPs) and competitive local exchange carriers (CLECs) began to market telephone and other data services to business customers. The terms CAPs and CLECs are sometimes used interchangeably. Often these services were provided over the CAP's wired networks. Later, some CAPs and other companies, including affiliates of cable television companies and local service divisions of long distance companies, began to offer local telephone services to a broader range of customers.

While various disparate technologies exist for consumers, more convenient and cost effective approaches to providing services to consumers are desired.

### SUMMARY OF THE INVENTION

Systems and methods for managing telephone communications are contemplated.

A telephone system is contemplated which incorporates and utilizes a softswitch. In one embodiment, the system comprises an originating carrier, and internet protocol (IP) network provider, a service platform, and a final carrier. The originating carrier is configured to originate a telephone call by users and convey the telephone calls to the IP network provider for termination. The IP network provider may convert the received telephone calls to a suitable protocol for conveyance, and convey the telephone call to the service platform. The service platform is generally configured to treat the telephone call utilizing a variety of services, and subsequently route the treated telephone call for termination with the final carrier. The final carrier receives and terminates telephone calls routed by the service platform.

In one embodiment, the originating carrier comprises a landline or wireless/cellular carrier which compensates the IP network provider for terminating calls conveyed by the originating carrier. The service platform may in turn compensate the IP network provider for telephone calls conveyed by the IP network provider to the service platform for termination. In one embodiment, the service platform is configured to route calls directly to the final carrier, and the final carrier is configured to compensate the service platform for termination of the calls. In an alternative embodiment, the service platform is configured to route telephone calls to the final carrier indirectly. In such an embodiment, telephone calls may be routed to the IP network provider for termination, which then conveys the telephone calls to the final carrier. In this embodiment, the IP network provider may compensate the service platform for routing the telephone calls to the IP network provider, and the final carrier compensates the IP network provider for conveying the routed and terminated telephone calls to the final carrier for termination.

These and other embodiments are contemplated and will be appreciated upon reference to the following description and drawings.

### BRIEF DESCRIPTION OF THE DRAWINGS

A better understanding of the present invention can be obtained when the following detailed description is considered in conjunction with the following drawings, in which:

FIG. 1 illustrates one embodiment of a telephone system.

FIG. 2 illustrates a telephone system including landline requirements for traditional POTS or broadband residential telephone service, as well as cellular/wireless service available to households.

FIGS. 3-6 illustrate various embodiments of a telephone system which eliminates a landline requirement for traditional POTS and broadband telephone service.

FIG. 7 illustrates one embodiment of a telephone system which supports both users who maintain a landline and those who wish to eliminate a landline.

FIG. 8 illustrates one embodiment of a service platform for use in a telephone system.

FIG. 9 illustrates one embodiment of a telephone system and the origination and termination of call flow.

FIG. 10 illustrates one embodiment of a method for originating, servicing, and termination telephone calls.

While the invention is described herein by way of example for several embodiments and illustrative drawings, those skilled in the art will recognize that the invention is not limited to the embodiments or drawings described. It should be understood that the drawings and detailed description thereto are not intended to limit the invention to the particular form disclosed, but on the contrary, the intention is to cover all modifications, equivalents and alternatives falling within the spirit and scope of the invention as defined by the appended claims.

### DETAILED DESCRIPTION OF THE INVENTION

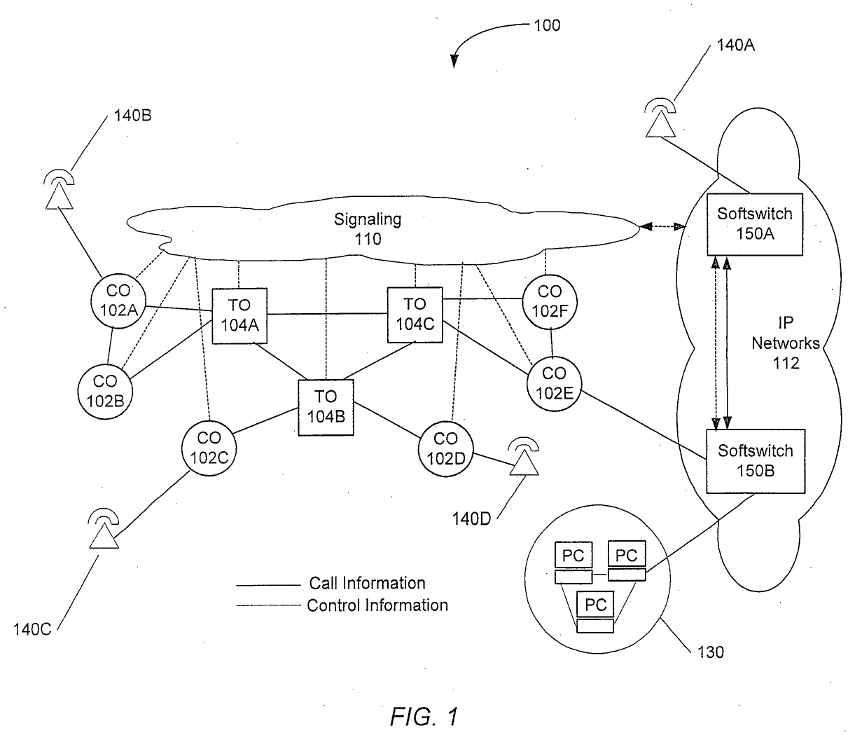

FIG. 1 depicts one embodiment of a network 100 which comprises a public switched telephone network (PSTN) and a voice over Internet protocol (VoIP) network. In the embodiment shown, the PSTN comprises a series of central offices (COs) 102A-102F, and tandem offices (TOs) 104A-104C. A distribution network connects the central offices 102 and tandem offices 104, and a signaling system 110 to control the various network elements. In one embodiment, the signaling system may comprise a packet switched data network such as the Common Channel Signaling System 7 (CCSS7). In the embodiment shown, an IP network(s) 112 is coupled to the signaling system 110. The signaling system 110 is integrated for call control when introducing Voice over Internet Protocol (VOIP). Also depicted are telephones 140A-140D, a local area network 130 with VoIP capabilities, and soft switches 150A-150B. Elements referred to herein with a particular reference number followed by a letter may be collectively referred to by the reference number alone. For example, central offices 102A-102F may be collectively referred to as central offices 102.

Generally speaking, traditional telephone systems have been based upon time division multiplexing (TDM). In such systems, any bandwidth which is unused is generally not sharable. Consequently, available bandwidth may not be fully utilized. In contrast to traditional TDM based systems, IP telephony utilizes IP protocols which are packet based. Using packet based transmission for voice and/or data may allow for greater efficiency by enabling the sharing of bandwidth—which may in turn result in reduced costs. IP has been the packet protocol of choice for voice because the overall volume of users' wide area network traffic has itself been dominated by IP. Due to the efficiencies associated with IP based systems, service providers and businesses took advantage of this efficiency and became early VOIP adopters. In addition, some service providers have replaced their TDM tandem switches with VoIP softswitches.

Softswitches 150 may generally comprise applications which emulate circuit switching in software. Accordingly, softswitches 150 may comprise software hosted on a server which further includes call control applications and drivers.

Because a softswitch comprises software, the addition of other functions and services, or the integration of third party applications, while operating with features of the PSTN via Signaling System 7 (SS7) may be more readily achieved. For example, features such as “cellular reconnect” and a “ring all” may be offered to users. This is one of the greatest advantages of utilizing softswitch technology.

A combination of analog and digital transmission technologies are used to transmit conversations within the network 100. While either analog or digital transmission techniques may be used in the “local loop” (i.e., from a consumer's premises to the local CO), virtually all transmissions between COs 102 may be digital. Utilizing digital transmission may result in improved quality and efficiency. In addition, digitizing voice data enables the multiplexing of voice and non-voice data over a given communication link.

Within digital telephone systems, common modulation techniques include pulse code modulation (PCM) and adaptive differential pulse code modulation (ADPCM). When PCM is used, each analog conversation is converted into a digital bit stream of 64,000 bits per second (64 kbps). ADPCM is a more technically advanced method for digitizing voice and reduces PCM's 64 kbps to 40, 32, 24, or even 16 kbps. For technologies like Voice over Internet Protocol (VoIP), additional digital voice encoding and compression schemes may permit even lower bandwidth to be used per call while maintaining acceptable call quality.

PCM with 64 kbps has been used in the PSTN for decades. Because of this use, 64 kbps increments (sometimes referred to as DS-0s) are the fundamental building blocks of digital transmission systems. In North America, the transmission system called “T-Carrier” bundles 24 DS-0s per T-1 line or channel (also called DS-1), for a total capacity of 1,544,000 bits per second (1.544 Mbps). A bundle of 28 T-1 lines may be referred to as a T-3 line (also called DS-3) with a total capacity of 45 Mbps. Multiple T-3 channels can be bundled or multiplexed into an optical channel (OC) at even higher speeds. Some countries use a similar system that combines 30 DS-Os into a single bundle called an E-1, and multiple E-1s are combined into E-3s. Each T-1, E-1, T-3, or E-3 transmission link can be channelized into 64 kbps streams (or multiples of 64 kbps streams). Alternatively, the entire transmission bandwidth may be used as a single entity, sometimes called “unchannelized” or “clear channel”.

Prior to the adoption of VOIP, almost all digital phone calls were sent over a time division multiplexed (TDM) link, and in many cases TDM is still the default multiplexing technique used today. Because each transmission receives a dedicated time slot for a user's voice or data, and that time slot cannot be over-run by another user's voice or data, TDM transmissions have a “built-in” quality of service (QoS). However, if the dedicated time slot is not used by the voice or data (e.g., a user is not saying anything during a particular period of time of a conversation), the user's time slot is in effect “wasted” since it cannot be shared with another user. While the backbone of the global telephone network had been largely converted to digital, the PSTN is still generally circuit-switched and may use PCM analog to digital conversion. Therefore, even though one person talks and the other listens, both “to” and “from” channels are always dedicated and bandwidth is wasted. In contrast, IP telephony compression schemes may cut bandwidth requirements from the traditional 64 kbps (PCM) down to 8 kbps with acceptable quality. Thus, the bandwidth requirement for voice on an IP network may be 1/16th that of the PSTN's dedicated, digital circuits.

In order to signal calls between users, the PSTN may employ a packet-based network called signaling system 110 such as signaling system 7 (SS7) or common channel signaling system 7 (CCSS7) to determine the call route, connect the callers, and generally provide call control. Central offices (COs) 102 operated by Local Exchange Carriers (LECs) provide basic features like dial tone, dialing (i.e., processing call set-up requests), and incoming call notification (e.g., electrical “ringing” current). COs 102 may also provide more sophisticated functions such as PBX type switching services. Together, the signaling network 110 and the COs 102 may provide other features like caller ID and call forwarding.

Private voice network systems like private branch exchanges (PBXs) and key systems (KTS) may also work with the PSTN to provide a hybrid public/private network. A PBX allows multiple users at a site to share incoming and out- going. PSTN trunk lines. Consequently, a site with a PBX does not have to dedicate individual PSTN lines to each user or phone station. The PBX may also provide features like call transfer, call pickup, auto attendant, and abbreviated number dialing to PBX extensions so that internal callers can bypass the PSTN and save additional expense. Key systems are similar to PBX systems, except that key systems rely on a telephone companies switching equipment, while a PBX generally relies on a central control unit located at the customer site. Centrex is another PBX type service offered by LECs, with a difference being that each phone station is linked back to the local central office so users do not have to share incoming and outgoing lines.

In addition to the above, PBX and key systems may also integrate other features such as voice mail, unified messaging, and interactive voice response (IVR) systems. Unified messaging systems allow common telephony user interface (TUI) and graphical user interfaces (GUI) to voice mail, email and fax. Automated Attendant/IVR systems interact with the caller to help direct calls based on the caller's selection of audio prompts. Additionally, dedicated circuits, often called “tie lines,” can be used to connect a company's PBXs at various locations, bypassing the PTSN.

Voice over IP (VoIP) technology is becoming increasingly important as businesses look at how they will communicate. Using VoIP, a business may save money on long distance and on moves/adds/changes (MACs) to their voice network, while offering cost-effective integrated communications tools like unified messaging and IVR. Long distance savings may be realized when a company has multiple sites and uses VoIP between its sites. Carriers have also taken advantage of IP to reduce long distance costs, contributing to the price reductions in long distance over the last several years. While VoIP may add a layer of complexity to a communications network, the cost-benefit may provide a near term and long term return on investment.

FIG. 1 also shows the signaling system 110 is integrated with the IP network(s) 112 for call control when introducing VOIP. Using IP to signal and transport voice brings several fundamental shifts to voice communications. As noted above, unused bandwidth cannot generally be shared in a TDM environment. In contrast, using packetized transmission for voice may allow for shared bandwidth and reduced costs. IP telephony typically uses two protocols: one for transport and another for signaling. User Datagram Protocol (UDP) is generally used for transport of voice packets over IP. UDP or Transmission Control Protocol (TCP) is generally used for signals over IP.

Signaling commands that establish and terminate calls, as well as providing special features such as call forwarding, call waiting, and conference calling, are defined in various signaling standards or protocols such as H.323 or Session Initiation Protocol (SIP). International Telecommunication Union-Telecommunication Standardization Sector (ITU-T) standard H.323 is an “umbrella” of standards for packet-based multimedia communications systems. This family of standards defines the different devices that make up a multimedia system, and includes the techniques to signal, control, and transmit voice, video, and data onto a converged network. SIP is a newer standard that differs from H.323 in that is offers presence information and can accommodate multiple, concurrent multimedia sessions. Presence information indicates that a user is (or is not) available to accept a call or data session. Concurrence allows a user to switch between or maintain simultaneous phone calls, web chat sessions, and document collaboration sessions. While H.323 is older than SIP and has been widely deployed in early implementation of VoIP, SIP has been gaining broader acceptance.

In legacy PSTN systems, voice network features are delivered to a user on a static pair of copper wires to a particular central office switch or PBX. In contrast, VoIP allows services to be delivered to a user anywhere the user is connected. Because of this, in the VoIP system, central office and PBX functions are provided in a distributed environment, and user proximity to the a particular central office or PBX becomes irrelevant. Further, users can remotely connect to their company's PBX and enjoy the full range of PBX features without being in the same location as their PBX.

The need for mobility, in the workplace as well as in our everyday lives, has driven rapid growth in the wireless communications services industry, which delivers voice and data over mobile telephones, pagers, and handheld computers.

More recently, the promise of the mobile Internet has added to imaginative ways that consumers and professionals alike utilize these services, which increasingly are being personalized to appeal to the individual user while fitting on smaller devices.

In addition to the need for mobility, the utilization of digital networks has contributed to the rapid growth in the wireless communications industry.

Digitalization may generally permit greater traffic capacity, lower prices, better sound quality, and data and Internet services. However, competing digital standards have slowed development of wireless services. For example, in the United States, various service providers may employ one or more of (Time Division Multiple Access) TDMA, (Code Division Multiple Access) CDMA, and (Global System for Mobile Communications) GSM. On the other hand, certain European nations and other nations have adopted a single standard (e.g., the GSM standard), making it easier for customers to use their mobile phones in different countries and spurring the development of customized data services.

Generally speaking, there are four disparate groups which provide data and/or voice systems and services. There are ILECs and CLECs offering traditional residential and business telephone services over landlines, VoIP LECs offering residential and business telephone services via the Internet, cellular/wireless carriers offering residential and business services in place of traditional landline telephone service, and finally there are enhanced service providers (ESPS) offering enhanced services to residences and businesses.

ILECs and CLECs currently have the largest installed consumer base. However, ILECs and CLECs have not offered a variety of services to these customers. For example, while these LECs could redirect a customer's home phone calls to a cell phone, they may be unlikely to do so because it may cannibalize their current investment in, and revenue from, their traditional residential service offerings.

VoIP LECs offer residential telephone services over a high speed Internet connection via Cable Modem service or Digital Subscriber Line (DSL) service. While such services may enable a consumer to bypass traditional telephone service providers, consumers must subscribe to a broadband Internet connection in order to use their services. In addition, the consumer cannot simply use their existing telephones with the service. Rather, the consumer is required to use specialized VoIP equipment that must be either purchased and/or received via shipment. Because there are millions of consumers who either can't afford or get broadband services, VoIP services may not be a viable option for many consumers. Similar to ILECs and CLECs, VoIP service providers may choose not to offer various services in order to protect their current investments.

The existence of cellular/wireless carriers provides the option for consumers to completely abandon their landline based telephone services and totally wireless or cellular. However, if consumers abandon a central home number or port their current home number to their cellular/wireless phone, consumers may lose the privacy they currently enjoy with their cellular phone service by having to give out their cellular phone number. In addition, they may lose any investment they have made in landline based household phones and lose the association of a central number for a residence.

Enhanced Service Providers (ESPs) offer services to businesses such as automated attendant, voicemail, and unified messaging capabilities. While some ESPs have offerings that can be used by consumers, ESPs typically target small office/home office (SOHO) and small business customers, and do not offer such services to households. Many ESPs serve customers over legacy TDM networks and PBX equipment. With few exceptions, ESPs require customers to subscribe to their voicemail service and pay usage sensitive charges to access their mailbox and complete calls. Similar to other service providers, ESPs may not offer various services because it may cannibalize their current investment and revenue from voice mailbox and long distance usage charges. In addition, many ESPs don't offer customers the ability to port their existing local numbers. Further, they do not allow local call completion without usage charges.

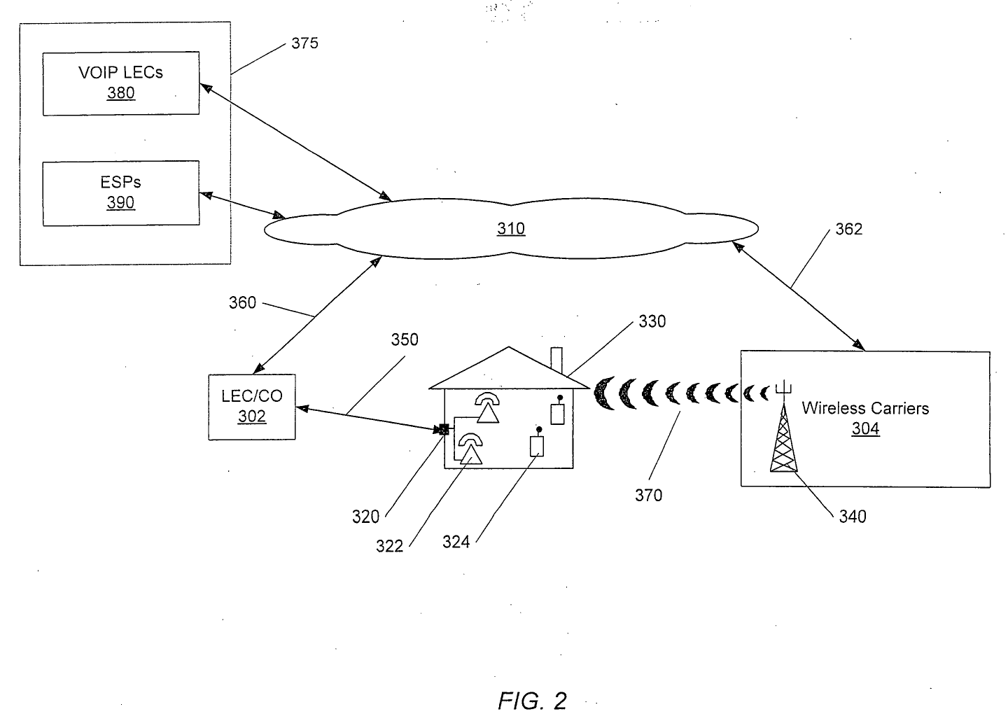

FIG. 2 illustrates an example of a system and its corresponding landline requirements. In the embodiment of FIG. 2, a system is shown which includes traditional POTS residential telephone service, as well as cellular/wireless service available to households. FIG. 2 includes a local exchange carrier/central office (LEC/CO) 302, wireless/cellular carrier network(s) 304, PSTN 310, and end user premises 330 (e.g., a household or business). Premises 330 is shown to include an interface 320 coupled to existing telephone wiring, telephone 322, and wireless/cellular telephone 324. Wireless carrier network 304 includes a wireless/cellular carrier tower 340 configured to provide a wireless/cellular connection 370 to an end user subscriber's wireless/cellular telephone 324. Interface 320 is coupled to LEC/CO 302 via a landline local loop 350. LEC/CO 302 is in turn coupled to PSTN 310 via LEC network connection 360. Finally, wireless carrier 304 is coupled to PSTN 310 via wireless/cellular network connection 362. Also depicted in FIG. 2 is are optional or alternative services 375. In the example shown, a VoIP LEC 380 may be coupled to PSTN 310, and/or an ESP 390 maybe coupled to PSTN 310.

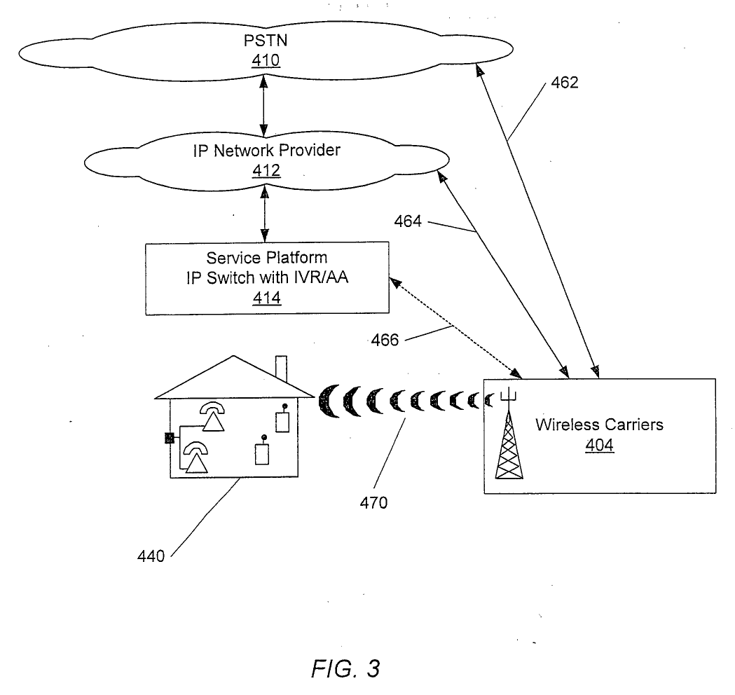

Turning now to FIG. 3, one embodiment of a system is shown which may provide a variety of services, while eliminating the requirement for a consumer to maintain a landline. Generally speaking, the system and approach depicted in FIG. 3 integrates the technologies of interactive voice response/automated attendants (IVR/AA), VoIP services, and cellular/wireless equipment and services in a unique way to offer consumer households an alternative to traditional landline and broadband telephone services, while offering a wide array of services in a cost effective manner. Included in FIG. 3 are a wireless/cellular carrier's network 404, PSTN 410, IP network provider 412, residential household or end user premises 440. Similar to the system depicted in FIG. 2, wireless/cellular carrier 404 includes a network connection 462 to a PSTN 410. In the embodiment shown, it is noted that no landline coupled to the premises 440 is included. In addition, an IP softswitch service platform with integrated voice response/automated attendant (IVR/AA) 414 has been incorporated into the system. Further, wireless carrier(s) 404 is coupled to IP network provider 412 via connection 464. Also shown is an optional, or alternative, connection between wireless carrier(s) 404 and service platform 414.

In one embodiment, service platform 414 is configured such that its operation and provision of services includes one or more of the following features:
(1) All incoming traffic is IP.
(2) All incoming traffic is received at a single location.
(3) The receiving location is collocated (either virtually or physically) with a final carrier (e.g., a cellular/wireless carrier).
(4) All received calls are “treated” and “routed” by a softswitch.
(5) All outgoing calls are IP.
(6) Most outgoing calls are handed off directly to final carriers. In such a case, the service platform 414 owner may be compensated by the final carrier for terminating IP call traffic with the final carrier.
(7) Outgoing calls which are not directly handed off to a final carrier may be handed to a service platform 414 IP network provider (IPNP) for transport and termination. The IPNP may then hand off the call to the final carrier. In such a case, the service platform 414 owner may compensate the IPNP for transporting the call traffic.
(8) Most of the final carriers may generally be wireless/cellular carriers.

In one embodiment, service platform 414 includes functionality to answer and direct calls to a customer's designated telephone number(s). These customer telephone numbers may be wireless numbers or otherwise. In one embodiment, the service platform 414 includes functionality to operate like an automated receptionist for a household or business, directing received calls to a designated cell phone or any other number desired. For example, when calling, a caller might hear a message similar to the following:
“Welcome to the Smith's answering service, your call will automatically be forwarded to the appropriate family member. Press or say “1” for Mrs. Smith, “2” for Mr. Smith, or “3” for the kids. (Optional—If this is an emergency, you can ring us all simultaneously by pressing or saying “4”.) Thank you for calling the Smith residence.”

In addition to the above, service platform 414 may also have the following capabilities: local or toll free numbers, customized greetings, caller ID, and Enhanced 911 (E911). Further features may also include day and night modes, do not disturb, telemarketing block, anonymous call block, call filtering, follow me, fax detection with forwarding and/or email delivery, unified messaging, ring all, conferencing, and cellular/wireless reconnect for dropped cell calls. All of which a customer may configure via a telephone, World Wide Web (Web), or otherwise.

Because a landline service is replaced with a wireless services, the system depicted in FIG. 3 may offer complimentary wireless products and services.

These products and services may include cellular services, cellular telephones, accessories and software. For example, docking stations for cellular phones may be used to allow existing home telephone equipment to work with the cellular service, rather than the traditional switched landline service. Another example could be the use of a wireless antenna and/or booster to amplify signals to your home. Numerous such alternatives are possible and are contemplated.

In the absence of a system and service platform 414 such as that depicted in FIG. 3, consumer households may have used both a landline local loop and wireless local loops to make and receive calls from the public switched network.

Utilizing the system and approach as depicted, consumers may retain their home number and “cut the cord” to their landline based telephone company.

Accordingly, the consumer may save duplicated costs resulting for local, long distance, voicemail, calling features, taxes, fees, and surcharges. In addition to the savings, customers may also enjoy greater mobility, convenience, and advanced features of wireless communications.

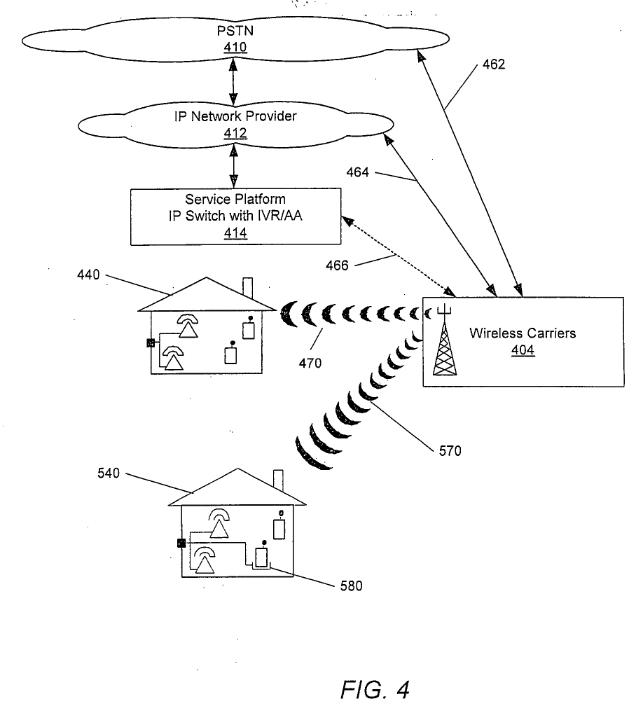

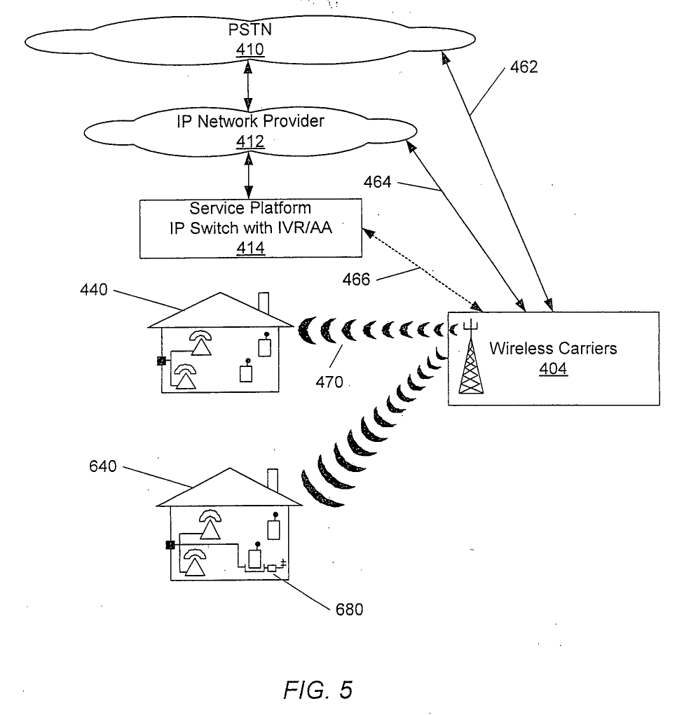

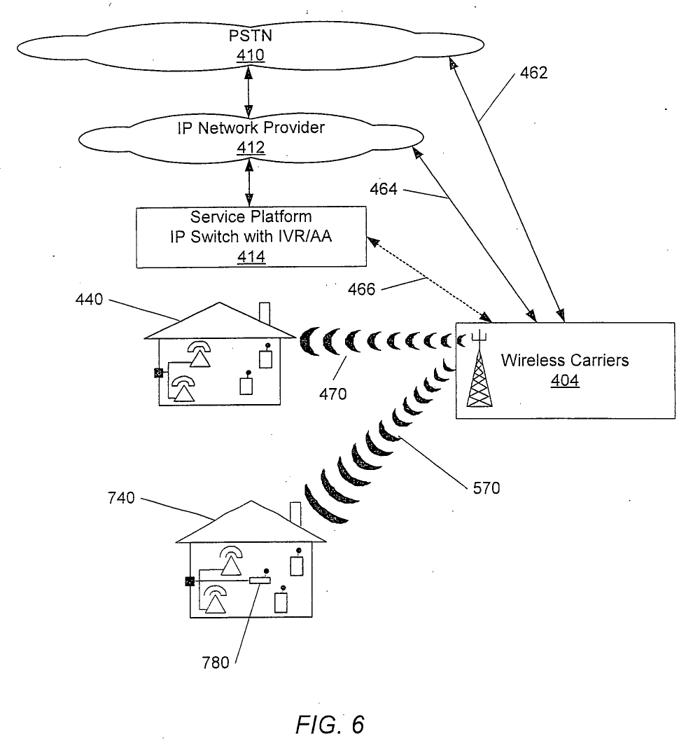

FIGS. 4-6 illustrate embodiments similar to that of FIG. 3 with like elements similarly numbered. In the embodiment of FIG. 4, a second household or premises 540 is shown to be coupled to the system via wireless connection 570. Household 540 includes an optional docking station 580 as described above which enables the use of existing household wiring and equipment. FIG. 5 depicts an embodiment wherein a premises 640 includes an antenna and signal booster 680 attached to a docking station which enables use of existing household wiring and equipment. FIG. 6 illustrates an embodiment including a premises 740 with an optional fixed wireless/cellular terminal and/or optional fixed wireless or broadband wireless terminal 780 enabling existing wiring and equipment, as well as cellular/wireless telephones. Various embodiments may include wireless broadband services at suitable points within a network, such as WiMAX, UMTS, HSDPA, HIPERMAN, or otherwise. It is noted that any of the above described options may be combined and utilized within a given system.

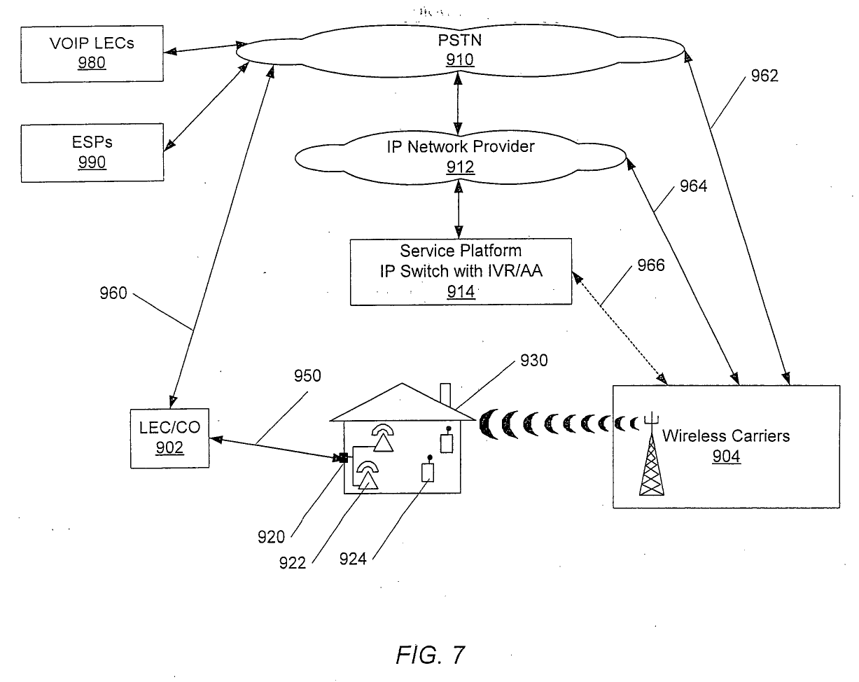

While the above described embodiments may allow a consumer to eliminate a landline, some may wish to retain their landline and enhance their existing traditional (POTS) and/or VOIP Broadband Telephone service. FIG. 7 illustrates an embodiment wherein a system includes a service platform 914 generally corresponding to service platform 414 discussed above, but which also includes a LEC/CO 902, ESP 990, and VoIP LEC 980. As before, the system includes a PSTN 910, IP network provider 912, service platform 914, wireless carrier 904, and premises 930. Premises 930 includes a telephone 922, wireless/cellular phone 924, and interface to existing telephone wiring 920.

The core component of the system which combines IP transport technology, IVR/automated attendant capabilities, and cellular/wireless products/services to provide a service which enables customers to keep their household number and eliminate the need for landline traditional (POTS) or VoIP broadband service, is the softswitch. As noted above, “soft” switching is a technology that has enabled VoIP to surpass TDM as the preeminent telephone technology. Physically, a softswitch comprises software hosted on a server which is generally populated with IP boards and includes call control applications and drivers. Generally speaking, the more powerful the server is, the more capable the softswitch. The softswitch is the intelligence in a network that coordinates call control, signaling, and features that make a call across a network or multiple networks possible. Softswitches may also provide usage statistics to coordinate billing, track operations, and administer functions of the platform while interfacing with signaling, media and trunking gateways, as well as an application server to deliver the number and type of features provided. It may also interface with application servers to coordinate features such as auto attendant, call forwarding, and conferencing for each call. Softswitches are sometimes referred to as a media gateway, media gateway controller, gatekeeper, call agent, call server, or even an P PBX, to reflect the fact that its switching is done in software, not in hardware as in previous switching generations.

The application/media server(s) are another component of new approach to service provision. These servers host applications to provide additional features to customers. Such features include interactive voice response/automated attendants (IVR/AA), call forwarding, conferencing, voicemail, faxing, etc. The softswitch may then utilize features provided by these application servers to provide services to customers. By using open standards in the development of the softswitch and related software and hardware components, the softswitch service provider may be freed from vendor dependence and the long and expensive service development cycles of legacy (TDM) switch manufacturers. Further, softswitch technology offers the advantage of enabling a softswitch based service provider to integrate third party applications or even write its own applications while operating with features of the PSTN via Signaling System 7 (SS7). For example, features which may be offered include “cellular reconnect” and “ring all” for its users.

In one embodiment, the softswitch is configured to be compliant with those recommendations or standards promulgated by the International Softswitch Consortium. For example, the softswitch may be configured such that it (1) controls connection services for a media gateway and/or native IP endpoints, (2) selects processes that can be applied to calls, (3) provides routing for a call within the network based on signaling and customer database information, (4) transfers control of the call to another network element, and (5) interfaces to and supports management functions such as provisioning, fault detection/correction, billing, etc. In addition, the softswitch may be configured to support existing and future IP protocols (such as, H.323, SIP, MEGACO, etc.). Still further, the softswitch may incorporate the functions of a router, media gateway, and application/media servers; or interface with components which provide these functions.

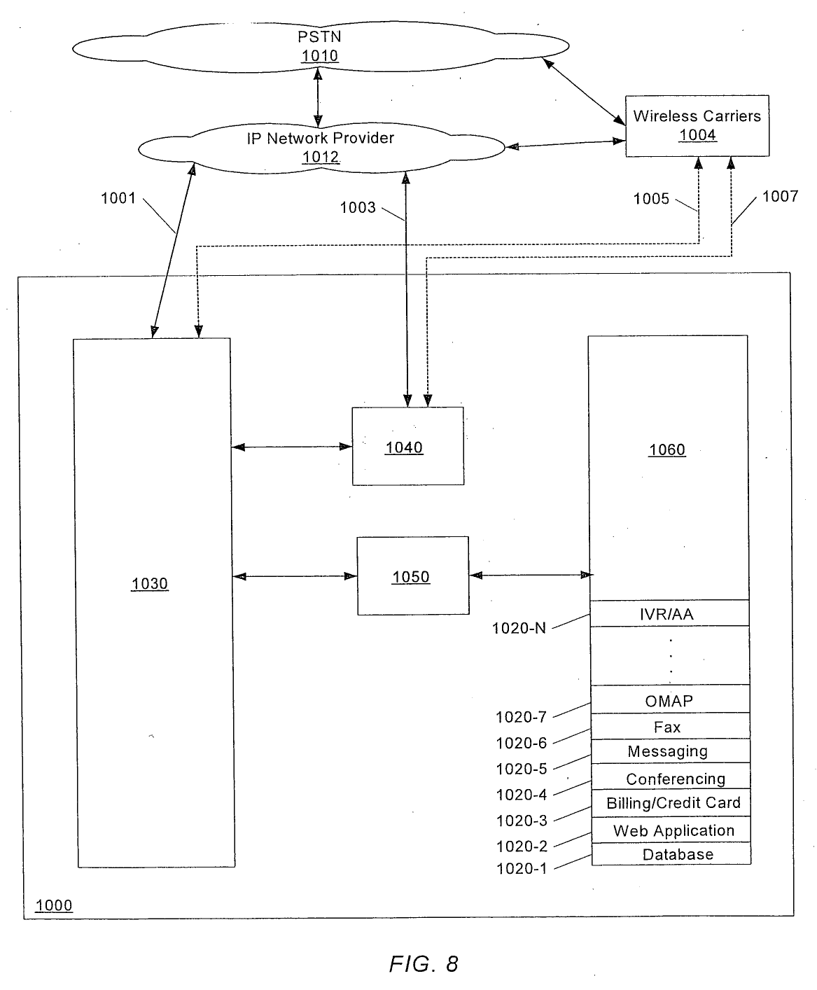

Turning now to FIG. 8, a system is shown with a more detailed depiction of a softswitch platform. It is noted that the softswitch service platform could be separately maintained, or could be collocated with another provider within a communications system, such as a cellular/wireless carrier or IP network provider. FIG. 8 shows a PSTN 1010 coupled to an IP network provider 1012 and wireless carrier(s) 1004. A softswitch platform 1000 includes a softswitch 1030, router 1040, media gateway 1050, and application/media server 1060 with integrated voice response/automated attendant server functions. It is noted that the functions of router 1040 and/or media gateway 1050 could be incorporated into the softswitch 1030 itself.

In the embodiment shown, softswitch 1030 is coupled to IP network provider 1012 via network connection 1001 and may transmit and receive peer to peer signaling via session initiation protocol (SIP) and/or integrated services digital network user part (ISUP) over IP. IP network 1012 is further coupled to router 1040 via network connection 1003. Communications between IP network provider 1012 and router 1040 may comprise voice internet protocol packets via protocols such as SIP, realtime transport protocol (RTP), or UDP. Also shown in FIG. 8 is an alternative network connections 1005 and 1007 between wireless/cellular carrier 10040 and service platform 1000. Connection 1005 may be used to communicate signaling information and connection 1007 may be used to transmitting voice internet protocol packets.

In one embodiment, application/media server 1060 is configured to provide a number of functions. For example, in FIG. 8, server 1060 comprises multiple functions or servers, including: database server 1020A, web application server 1020B, billing/credit card server 1020C, conferencing server 1020D, messaging server 1020E, fax server 1020F, operations, maintenance, and provisioning server 1020G, and IVR/AA server 1020N, and any other desired application servers. In one embodiment, the IVR/AA server 1020N provides an automated telephone information system that speaks to callers with a combination of fixed voice menus and real-time data from databases. The callers may respond by pressing digits on their telephone or speaking words or short phrases. The automated attendant is a part of the IVR/AA that generally replaces a human operator and directs the caller to the appropriate number or voice mailbox.

In addition to the above, the softswitch 1030 may register customers and handle their provisioning, accept inbound IP signaling traffic, direct voice packets to appropriate application/media servers 1020, interpret and treat calls, route outbound IP traffic with an IP network provider or to a final carrier (e.g., wireless/cellular), assign and manage numbers and features (such as IVR/Automated Attendant, Caller ID name and number, call forwarding, caller filtering/screening, do not disturb, anonymous call rejection, fax detection/forwarding, broadcast and sequential ringing, conferencing, cellular/wireless call reconnect, etc.), support E911, 711 telecommunications relay services (TRS), services related to the Communications Assistance for Law Enforcement Act (CALEA), and bills customers.

may be appreciated, the quality of service (QoS) will be dependent not only on the service platform 1000 equipment and software, but the corresponding supplier networks and people who operate them as well. Voice quality of the PSTN (Public Switched Telephone Network) is the standard for telephone service. As is well known, service on the landline PSTN is known for the absence of echo, crosstalk, latency, dropped or blocked calls, noise, or any other degradation of voice quality. Wireless carrier network quality is generally not as good as landline carrier network quality. However, wireless quality has been improving and customers are becoming more tolerant of wireless voice call quality.

In one embodiment, the IP network provider 1012 is configured to: (1) provide local number portability (LNP), local direct inward dialing (DID) numbers, and/or toll free numbers, (2) accept inbound PSTN traffic and terminate outbound traffic to the PSTN, and possibly to wireless/cellular carriers, (3) convert inbound traffic to IP and deliver it to the service provider platform 1000, (4) convert outbound traffic from IP for the PSTN, and possibly wireless/cellular carriers, (5) provide support of E911, 711/TRS, & CALEA, (6) provide support for Operator Assistance/Directory Assistance (OA/DA) and other network services, and (7) agree to a service level agreement (SLA) provided or approved by the service platform 1000 owner or operator.

As noted above, the IP network provider 1012 may be configured to provide local DID numbers which enable a caller to call an individual directly. With recent advancements in IP transport technologies, several IP network providers now offer local origination services with local DID number availability in thousands of local rate centers across the U.S. Utilizing these DID numbers, service platform 1000 based services may be provided to most of the population with minimal inbound transport costs.

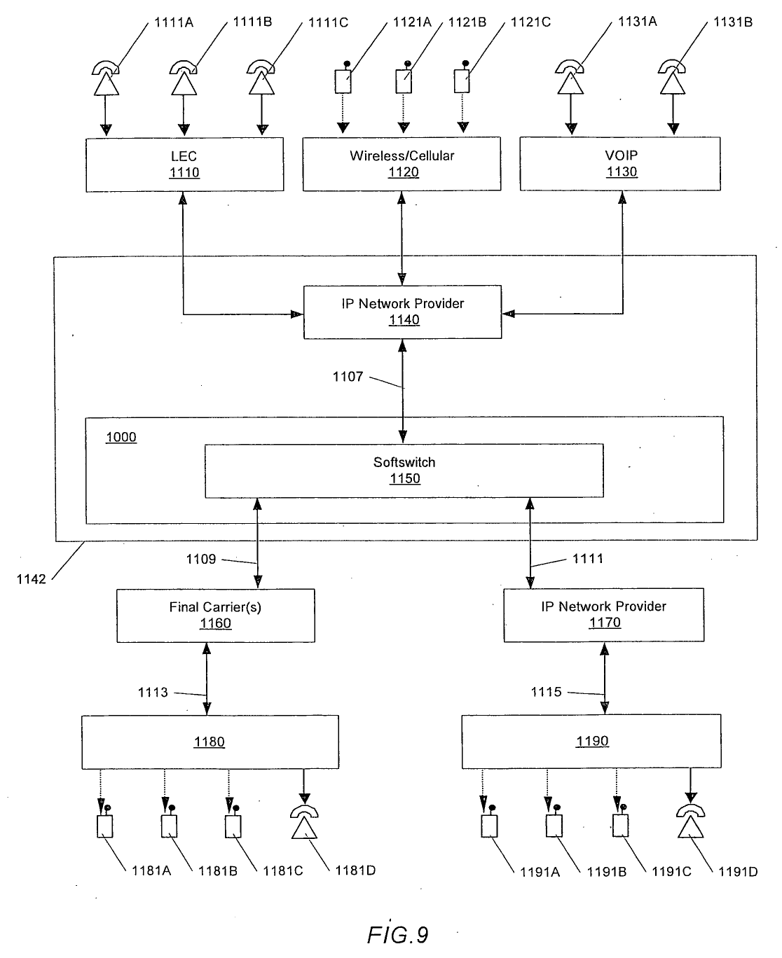

FIG. 9 illustrates one embodiment of the origination and termination of call flow in a system utilizing service platform 1000. FIG. 9 depicts a LEC 1110, wireless/cellular carrier 1120, VoIP provider 1130, and service platform 1000—all of which are coupled to communicate with IP network provider 1140. Block 1142 indicates that IP network provider 1140 and platform 1000 may be collocated. In such an embodiment, service platform 1000 owner/operator may compensate the IP network provider 1140 for collocation space. Service platform 1000 is coupled with final carrier(s) 1160 and IP network provider 1170. It is noted that IP network provider 1170 may be the same provider as IP network provider 1140. Block 1180 represents a final carrier network endpoint for termination of a call with an end user. It is noted that final carrier 1180 may be a same carrier as final carrier 1160. Block 1190 also represents a final carrier network endpoint for termination of a call with an end user.

Also depicted are customers/users of the system (e.g., telephone service customers depicted as telephones). For ease of discussion, particular users will be described as corresponding to the originating end of a call while others are described as corresponding to the terminating end of a call. However, calls may of course originate and terminate in an opposite direction than that described. LEC 1110 is shown coupled to telephones 1111A-1111C, wireless/cellular carrier 1120 is coupled to customers 1121A-1121C, VoIP provider 1130 is coupled to customers 1131A-1131B, endpoint 1180 is coupled to customers 1181A-1181D, and endpoint 1190 is coupled to customers 1191A-1191D.

Generally speaking, the service platform 1000 operator contracts service with an IP network provider 1140. As part of the agreement, the IP network provider 1140 may allocate blocks of (direct inward dialing) DID numbers in the markets that the service platform 1000 operator is targeting. Customers may then contract for telephone service with the service platform 1000 operator. The service platform 1000 operator may then assign DID numbers to their customers, and may eventually port the end user's original number (e.g., a landline number) to its service network. For purposes of discussion, assume that the DID number and porting may, for example, cost the service platform operator approximately $25 one time and $2.75 per number per month. When someone calls that DID or ported end user's number, the call originates and is transported via the IP network 1140 to a single interconnection facility (i.e., the service platform 1000). The IP call traffic may then be handed off via Session Initiation Protocol (SIP) to the service platform 1000 softswitch 1150. At an estimated cost of approximately $0.01/minute for the conversion to IP, transport, and termination on the softswitch 1150, this arrangement may allow the platform 1000 owner/operator to save costs associated with the transport of originating call traffic and interconnection with the traditional Public Switched Telephone Network (PSTN).

When the originating call is handed off to the platform 1000, the softswitch 1050 may “treat” it with appropriate features and route the call via IP to a final (or terminating) carrier. Treating a particular call may generally comprise associating an application with the call and applying or providing one or more services as required. Routing the calls via IP to a final carrier may be performed either directly or indirectly. In the direct approach, the softswitch 1050 may be physically located in close proximity (“collocated”) with the final carrier (e.g., local exchange, VOIP, or wireless). As a result, the transport and interconnection costs to deliver calls to these carriers may be substantially reduced, or virtually eliminated. In one embodiment, if the platform 1000 hands off the IP call traffic directly to the final carrier, that final carrier may generally compensate the platform 1000 owner/operator to terminate IP calls on the final carrier's network. For example, the final carrier may compensate the platform 1000 owner/operator approximately 0.01/minute. Once the call is with the final carrier, it can then transport and terminate the call to its end users.

As noted above, the softswitch 1050 may also route calls via IP to a final carrier indirectly. For example, some final carriers may require that the platform 1000 owner/operator terminate calls locally (e.g., at the local NPA-NXX level). In such a case, platform 1000 owner/operator may terminate IP calls with them indirectly via IP network provider 1140, who may then transport and terminate the call at a fraction of the cost (e.g., ˜0.01/minute) of using a traditional carrier. While routing to final carriers may be performed either directly or indirectly, in one embodiment the platform 1000 owner/operator may prefer to hand off all IP call traffic directly to final carriers. In this manner, an arrangement is created where the platform 1000 owner/operator is compensated for terminating IP call traffic, and its overall IP call transport and interconnection costs are reduced.

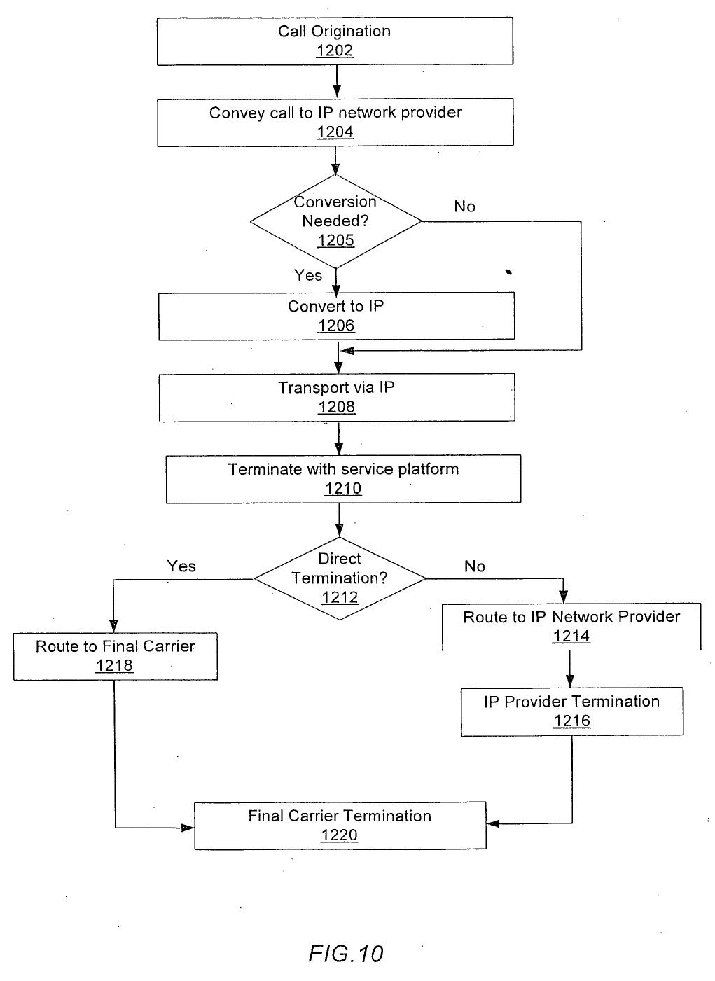

FIG. 10 illustrates one embodiment of a method for originating and terminating calls in a system with a service platform and softswitch such as the platform 1000 in FIG. 9. Initially, a user originates a call (block 1202) via their carrier. For example, referring to FIG. 9, a user may originate a call with any of LEC 1110, wireless/cellular carrier 1120, or VoIP carrier 1130. Generally speaking, end users compensate their respective originating carrier for call traffic. Subsequent to origination of a call, the originating carrier then terminates the call with the service platform 1000 provider's IP network provider 1140. In such an embodiment, the originating carrier may generally compensate the IP network provider for terminating the call (e.g., 1.0 cents/minute).

After terminating the call, the IP network provider may then determine (decision block 1205) whether it is necessary to convert the call to an alternate protocol.

For example, the IP network provider may convert a received call to an IP compatible protocol and transport (block 1208) the received call via IP to the service platform 1000 where the call is terminated (block 1210). It is noted that the service platform 1000 may be collocated with the IP network provider 1140, or a wireless/cellular carrier 1120. Service platform 1000 owner/operator may then compensate the IP network provider 1140 for call termination. In an embodiment wherein the wirelss/cellular carrier 1120 is collocated with the IP network provider 1140, wireless/cellular carrier 1120 may be seen as directly coupled to service platform 1000.

As discussed above, platform 1000 operator may terminate calls either directly or indirectly. If a call is to be terminated directly (decision block 1212), the call may be routed to the final carrier (block 1218) where it is terminated (block 1220). In such a case, the final carrier may compensate the platform 1000 operator for terminating the call with the final carrier. If the call is to be terminated indirectly (decision block 1212), the call may then be routed to the platform 1000 operator's IP network provider (e.g., IP network provider 1170 in FIG. 9) (block 1214) for termination (block 1216). In this case, the IP network provider 1170 may compensate the platform 1000 operator for call termination. The IP network provider may then terminate the call with the final carrier (block 1220). The final carrier may generally compensate the IP network provider for terminating the call with the final carrier. Further, the final carrier is compensated by the end user.

In an alternative embodiment, a wireless carrier may comprise, or be directly coupled to, a softswitch. In such an embodiment, the wireless carrier may be configured to perform necessary IP related functions. For example, in FIG. 10, blocks 1202, 1205, 1206, and 1208 may be performed entirely within a wireless carrier. As such, the wireless carrier may transport telephone calls via IP protocol for termination with the service platform (1210). Accordingly, conveyance to an intermediary IP network provider (block 1204) may not be needed.

Utilizing the systems and methods described above, consumers may save costs on telephone service by eliminating duplicate expenses associated with their landline telecommunications services of local, long distance, voicemail, calling features; and taxes, fees, and surcharges. In addition, the services provided by the service platform may also offers them time savings and the convenience of just having to check one voicemail box, versus their wireless and landline voicemail box; as well as answering calls directed to them rather than another family member. As advancements in cellular phones and services continue, the value of this personalization will only increase. In addition, by utilizing a wireless docking station that enables wireless calls to be answered and made from existing home telephone equipment, a consumer can keep the investment they've made in their existing equipment.

It is noted that the above described embodiments may comprise software. In such an embodiment, the program instructions which implement the methods and/or mechanisms may be conveyed or stored on a computer accessible medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Thus, various embodiments may further include receiving, sending or storing instructions and/or data implemented in accordance with the foregoing description upon a computer accessible medium. Numerous variations and modifications will become apparent to those skilled in the art once the above disclosure is fully appreciated. It is intended that the following claims be interpreted to embrace all such variations and modifications.

What is claimed is:

1. A system comprising:
an originating carrier configured to originate a telephone call by a user and convey the telephone call in an internet protocol (IP) format;
a service platform coupled to receive said telephone call in the IP format, wherein the service platform comprises a softswitch configured to:
terminate the telephone call; and
treat the telephone call by associating one or more features with the telephone call; and
route the treated telephone call;
a final carrier configured to terminate telephone calls routed by the service platform.

2. The system as recited in claim 1, wherein the originating carrier comprises a local exchange carrier, wireless/cellular carrier, or VOIP provider.

3. The system as recited in claim 2, further comprising an IP network provider coupled to the originating carrier, wherein the IP network provider is configured to terminate telephone calls received from the originating carrier.

4. The system as recited in claim 3, wherein the service platform is coupled to receive said telephone call from either the originating carrier or the IP network provider.

5. The system as recited in claim 4, wherein the originating carrier comprises the IP network provider.

6. The system as recited in claim 1, wherein the originating carrier compensates the IP network provider for terminating calls conveyed by the originating carrier.

7. The system as recited in claim 6, wherein the service platform compensates the IP network provider for telephone calls conveyed by the IP network provider to the service platform for termination.

8. The system as recited in claim 7, wherein the service platform is configured to route calls directly to the final carrier, and wherein the final carrier is configured to compensate the service platform for termination of calls received from the service platform.

9. The system as recited in claim 7, wherein the service platform is configured to route the terminated telephone calls to the IP network provider for termination, and wherein the IP network provider is configured to convey the routed and terminated telephone calls to the final carrier for termination.

10. The system as recited in claim 9, wherein the IP network provider compensates the service platform for routing the terminated calls to the IP network provider for termination.

11. The system as recited in claim 10, wherein the final carrier compensates the IP network provider for conveying the routed and terminated telephone calls to the final carrier for termination.

12. A method comprising:
initiating a telephone call by a user with an originating carrier and conveying the telephone call in an internet protocol (IP) format;
receiving said telephone call in the IP format at a service platform comprising a softswitch, terminating the telephone call in the service platform, treating the telephone call by associating one or more features with the telephone call, and routing the treated telephone call;
receiving and terminating the routed telephone call in a final carrier.

13. The method as recited in claim 12, wherein the originating carrier comprises a local exchange carrier, wireless/cellular carrier, or VOIP provider.

14. The method as recited in claim 13, further comprising conveying the telephone call from the originating carrier to an IP network provider, and terminating the telephone call with the IP network provider.

15. The method as recited in claim 14, wherein the service platform is coupled to receive said telephone call from either the originating carrier or the IP network provider.

16. The method as recited in claim 15, wherein the originating carrier comprises the IP network provider.

17. The method as recited in claim 16, further comprising the originating carrier compensating the IP network provider for terminating calls conveyed by the originating carrier.

18. The method as recited in claim 17, further comprising the service platform compensating the IP network provider for telephone calls conveyed by the IP network provider to the service platform for termination.

19. The method as recited in claim 18, wherein the service platform is configured to route calls directly to the final carrier, and wherein the method further comprises the final carrier compensating the service platform for termination of calls received from the service platform.

20. The method as recited in claim 18, further comprising:
routing the terminated telephone calls from the service platform to the IP network provider for termination; and
conveying the routed and terminated telephone calls from the IP network provider to the final carrier for termination.

21. The method as recited in claim 20, further comprising the IP network provider compensating the service platform for routing the terminated calls to the IP network provider for termination.

22. The method as recited in claim 21, further comprising the final carrier compensating the IP network provider for conveying the routed and terminated telephone calls to the final carrier for termination.

23. A service platform for use in a telephone system, the service platform comprising:
a softswitch coupled to receive telephone calls in an internet protocol (IP) format;
a router; and
an application server;
wherein the softswitch is configured to terminate received telephone calls, and utilize the application server to apply one or more services to a received and terminated phone call; and
wherein the router is configured to route the terminated telephone calls to a final carrier.
